(19) United States
(12) Patent Application Publication
(10) Pub. No.: US 2016/0322776 A1
(43) Pub. Date: Nov. 3, 2016

(54) CO2-N2-HE GAS DYNAMIC LASER

(71) Applicants: Devin Benjamin Richardson, San Antonio, TX (US); Jack Lloyd-Reilley, San Antonio, TX (US); Pourya Samari, San Antonio, TX (US); Jennifer Steffany Rodriguez, San Antonio, TX (US); Arturo Alejo Ayon, San Antonio, TX (US)

(72) Inventors: Devin Benjamin Richardson, San Antonio, TX (US); Jack Lloyd-Reilley, San Antonio, TX (US); Pourya Samari, San Antonio, TX (US); Jennifer Steffany Rodriguez, San Antonio, TX (US); Arturo Alejo Ayon, San Antonio, TX (US)

(21) Appl. No.: 15/141,797

(22) Filed: Apr. 28, 2016

Related U.S. Application Data
(60) Provisional application No. 62/154,094, filed on Apr. 28, 2015.

(51) Int. Cl. H01S 3/0953; H01S 3/225; H01S 3/105; H01S 3/223; H01S 3/036; H01S 3/034

(52) U.S. Cl. CPC H01S 3/0953; H01S 3/036; H01S 3/034; H01S 3/105; H01S 3/2232; H01S 3/2237; H01S 3/225

(57) ABSTRACT

Disclosed herein is a CO2-N2-He gas dynamic laser. The operation of a gas dynamic laser involves heating the gas, rapidly cooling that gas in a supersonic nozzle, flowing the gas through an optical cavity wherein stimulated emission (lasing) takes place, and exhausting the gas. Isentropic equations are used to find flow properties throughout the nozzle and diffuser from the properties at their inlets in order to produce a Shock-Free minimum length nozzle.

### CROSS-REFERENCE TO RELATED APPLICATIONS

This application claims the benefit under Title 35 United States Code §119(e) of U.S. Provisional Patent Application Ser. No.: 62/154,094; Filed: Apr. 28, 2015, the full disclosure of which is incorporated herein by reference.

### STATEMENT REGARDING FEDERALLY SPONSORED RESEARCH OR DEVELOPMENT

None

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention relates generally to a system, device, and method for a laser.

### BACKGROUND OF THE INVENTION

Without limiting the scope of the disclosed systems, devices, and methods, the background is described in connection with a novel laser. For over 50 years thick steel cuts (used in ship-building and bridge making) have required a high pressure water jet. This equipment was engineered over 100 years ago with only small changes being made since then. Issues with this equipment include painfully slow job times, high maintenance costs, and the extreme amount of resources wasted during use. Another option is the quick and precise CO2 laser. This laser is common among the sheet metal machining industry. Cuts under ¾ of inch can be easily cut in a few seconds, for a fraction of the cost of a water jet.

### BRIEF SUMMARY OF THE INVENTION

The present invention, therefore, provides for systems, devices, and methods for a CO2-N2-He gas dynamic laser. The operation of a gas dynamic laser involves heating the gas, rapidly cooling that gas in a supersonic nozzle, flowing the gas through an optical cavity wherein stimulated emission (lasing) takes place, and exhausting the gas.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 graphs nozzle characteristics from isentropic equations in accordance with embodiments of the present disclosure;

FIG. 2 graphs nozzle temperature drop in accordance with embodiments of the present disclosure;

FIG. 3 is an exploded assembly of the CO2-N2-He gas dynamic laser in accordance with embodiments of the present disclosure;

FIG. 4 is a subassembly view of the CO2-N2-He gas dynamic laser in accordance with embodiments of the present disclosure;

FIG. 5 shows nozzle placement and critical pocket dimensions of the CO2-N2-He gas dynamic laser in accordance with embodiments of the present disclosure;

FIG. 6 is a main body view of the CO2-N2-He gas dynamic laser in accordance with embodiments of the present disclosure;

FIG. 7 illustrates the critical pocket dimensions of the main block of the CO2-N2-He gas dynamic laser in accordance with embodiments of the present disclosure;

FIG. 8 illustrates the removable nozzle plates of the CO2-N2-He gas dynamic laser in accordance with embodiments of the present disclosure;

FIG. 9 illustrates the top block of the CO2-N2-He gas dynamic laser in accordance with embodiments of the present disclosure;

FIG. 10 illustrates the window blocks of the CO2-N2-He gas dynamic laser in accordance with embodiments of the present disclosure;

FIG. 11 illustrates the optics mount allowing securement of the full laser body of the CO2-N2-He gas dynamic laser in accordance with embodiments of the present disclosure;

FIG. 12 illustrates the laser mount of the CO2-N2-He gas dynamic laser in accordance with embodiments of the present disclosure;

FIG. 13 illustrates the micrometer bracker of the CO2-N2-He gas dynamic laser in accordance with embodiments of the present disclosure;

FIG. 14 illustrates the wishbone gimbal of the CO2-N2-He gas dynamic laser in accordance with embodiments of the present disclosure;

FIG. 15 illustrates the outer gimbal of the CO2-N2-He gas dynamic laser in accordance with embodiments of the present disclosure;

FIG. 16 illustrates the mirror retainer plate of the CO2-N2-He gas dynamic laser in accordance with embodiments of the present disclosure;

FIG. 17 illustrates the fixed mount and retainer plate of the CO2-N2-He gas dynamic laser in accordance with embodiments of the present disclosure;

FIG. 18 illustrates the complete optical system of the CO2-N2-He gas dynamic laser in accordance with embodiments of the present disclosure;

FIG. 19 illustrates the tube to hose connector of the CO2-N2-He gas dynamic laser in accordance with embodiments of the present disclosure;

FIG. 20 is the plenum shell of the CO2-N2-He gas dynamic laser in accordance with embodiments of the present disclosure;

FIG. 21 is the plenum cap of the CO2-N2-He gas dynamic laser in accordance with embodiments of the present disclosure;

FIG. 22 illustrates nozzle properties by mach number in accordance with embodiments of the present disclosure;

FIG. 23 illustrates a minimum length nozzle in accordance with embodiments of the present disclosure;

FIG. 24 illustrates a nozzle profile in accordance with embodiments of the present disclosure;

FIG. 25 illustrates nozzle temperature drop in accordance with embodiments of the present disclosure;

FIG. 26 is the assembled nozzle of the CO2-N2-He gas dynamic laser in accordance with embodiments of the present disclosure.

### DETAILED DESCRIPTION OF THE INVENTION

Disclosed herein are systems and methods of use for fast bandwidth repair for a big-data source. The numerous innovative teachings of the present invention will be described with particular reference to several embodiments (by way of example, and not of limitation).

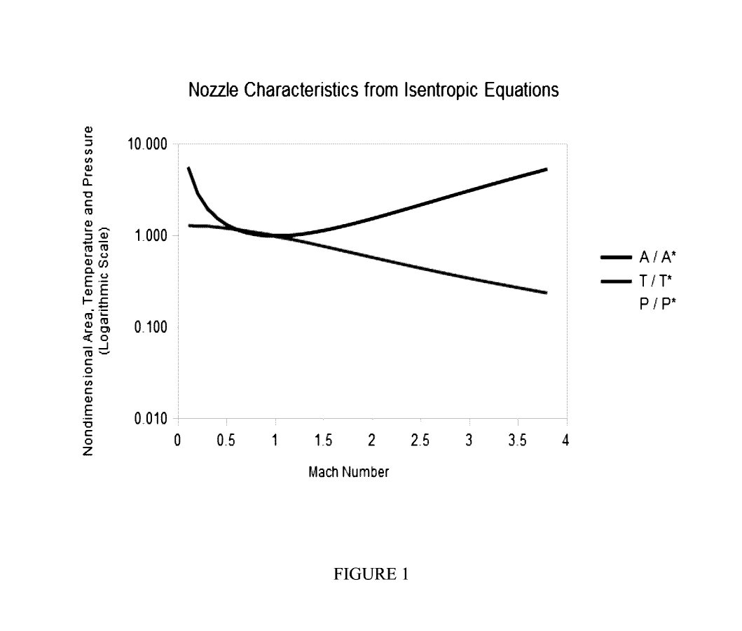

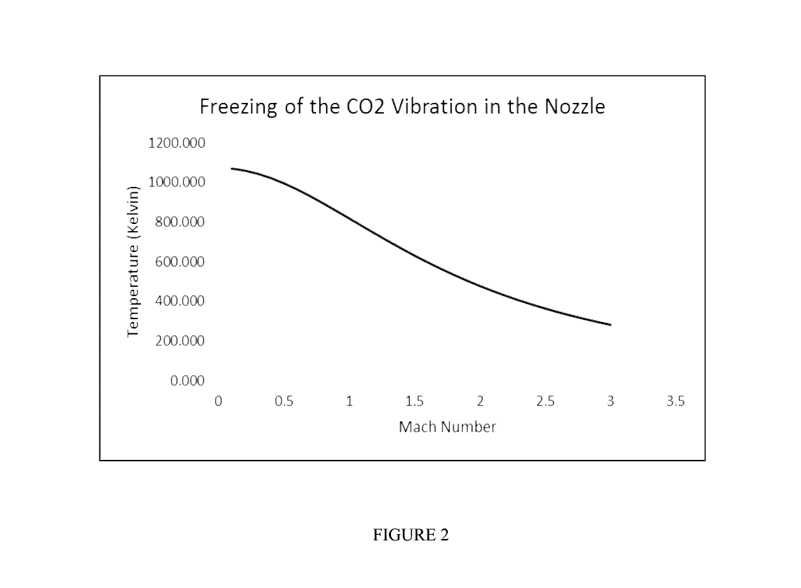

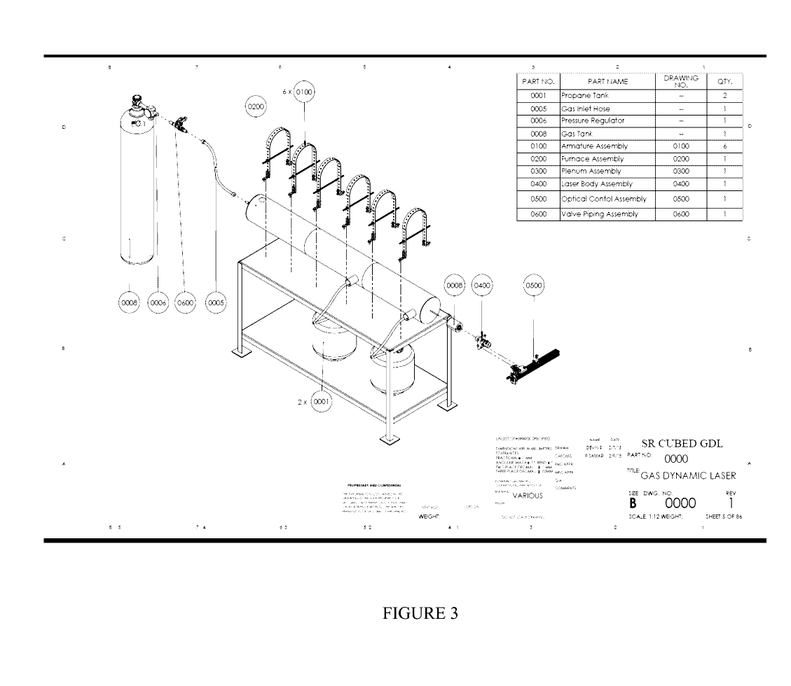

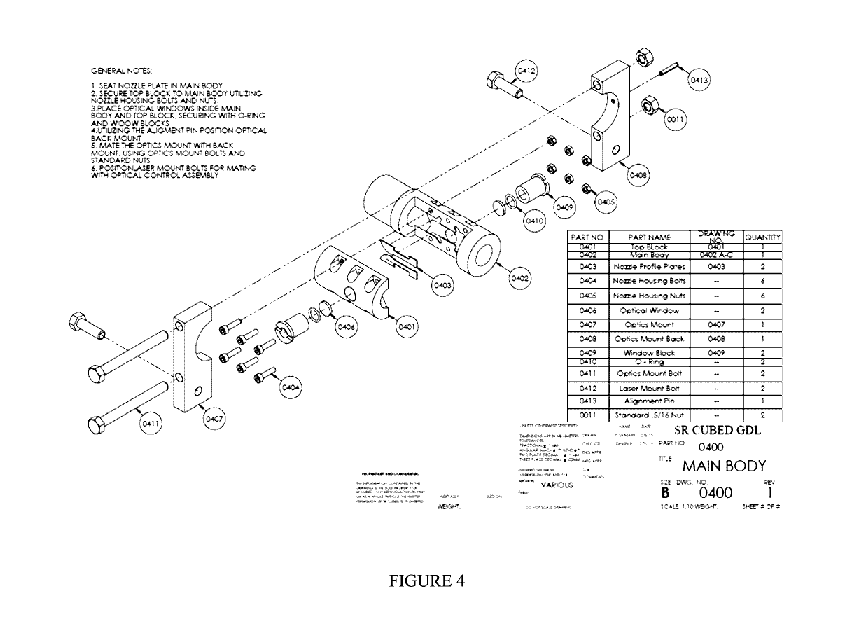

Disclosed herein is a CO2-N2-He Gas Dynamic Laser. The operation of a gas dynamic laser involves heating the gas, rapidly cooling that gas in a supersonic nozzle, flowing the gas through an optical cavity wherein stimulated emission (lasing) takes place, and exhausting the used gas. FIG. 1 illustrates typical nozzle properties by mach number, developed via use of these isentropic equations. Semilog—Y scale. FIG. 2 illustrates nozzle temperature drop. Note that temperature falls below the freezing line just before the throat. FIG. 3 illustrates the exploded assembly of a gas dynamic laser. FIG. 4 illustrates the laser body subassembly.

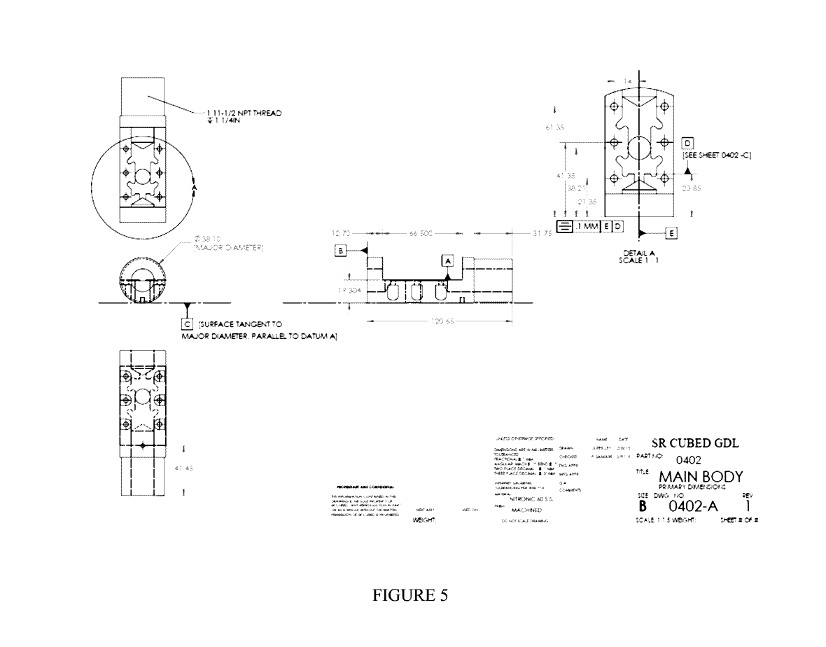

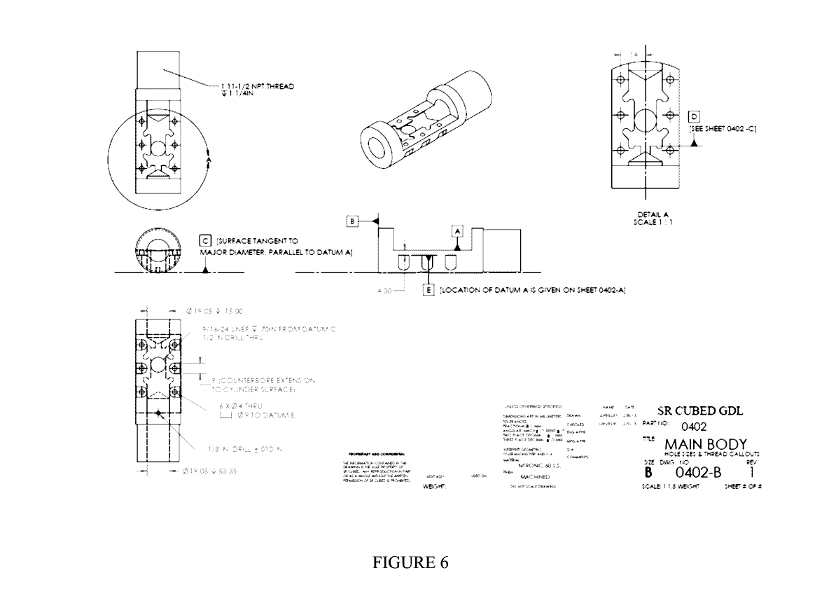

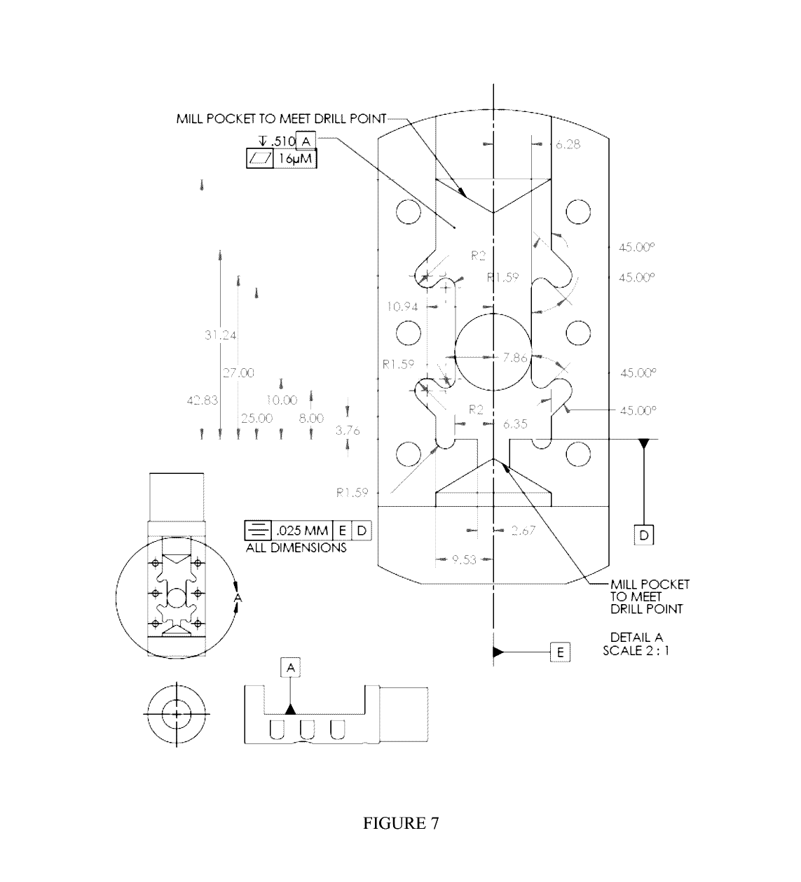

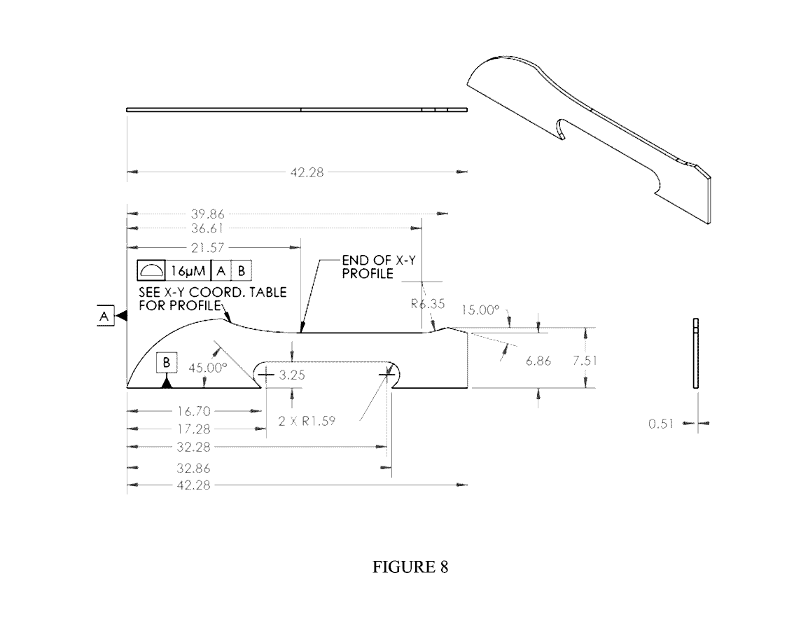

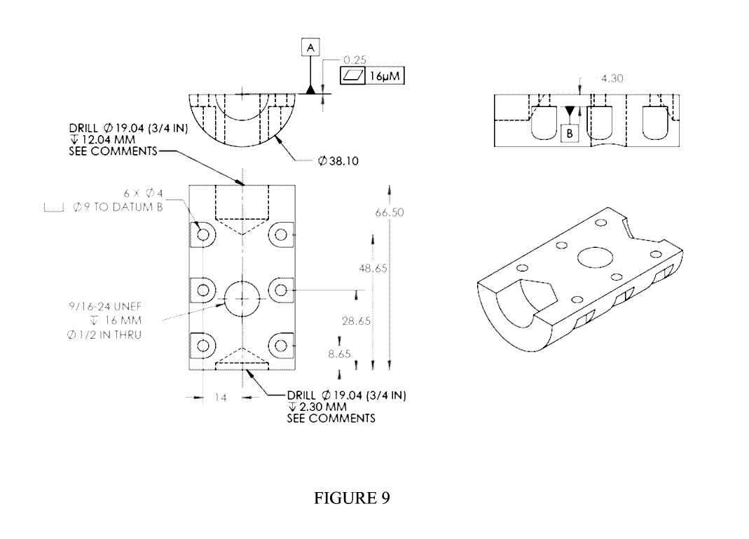

The geometry of the main body includes a nozzle passage formed by two replaceable nozzle plates 403 are held into the main block by a dovetail shaped pocket. FIG. 5 illustrates the nozzle placement and the critical pocket dimensions. FIG. 6 illustrates another view of the main body. FIG. 7 illustrates the critical pocket dimensions of the main block. The nozzle plates are illustrated in FIG. 8. The top block is illustrated in FIG. 9.

The main body block may be constructed from various materials known in the art. In embodiments, the main body may be constructed from Nitronic 60 or 303 stainless steel. The selection of material may affect the duration of the laser's operation.

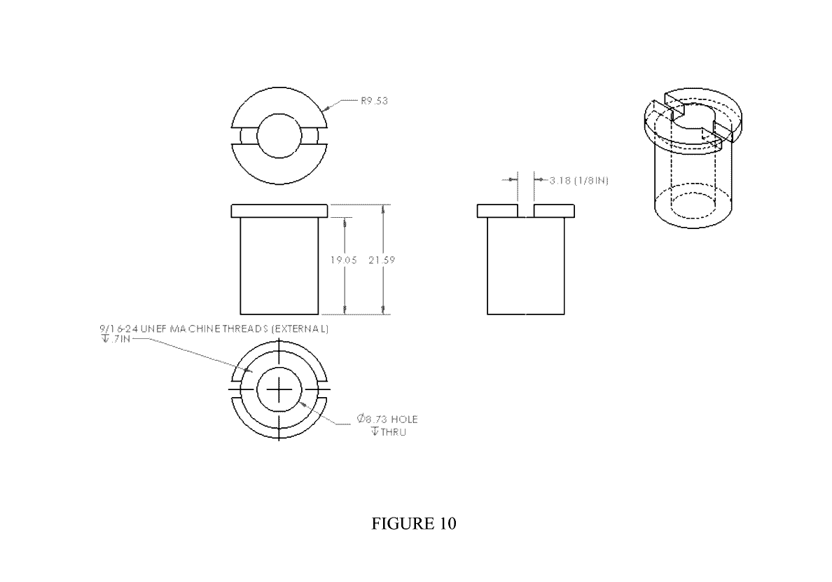

Two windows blocks which hold the ZnSe windows and which insert into the top block and the main body block, respectively. FIG. 10 illustrates the window blocks.

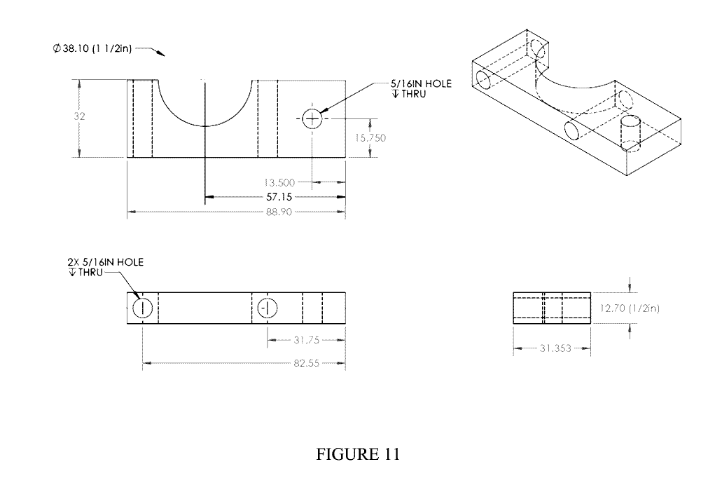

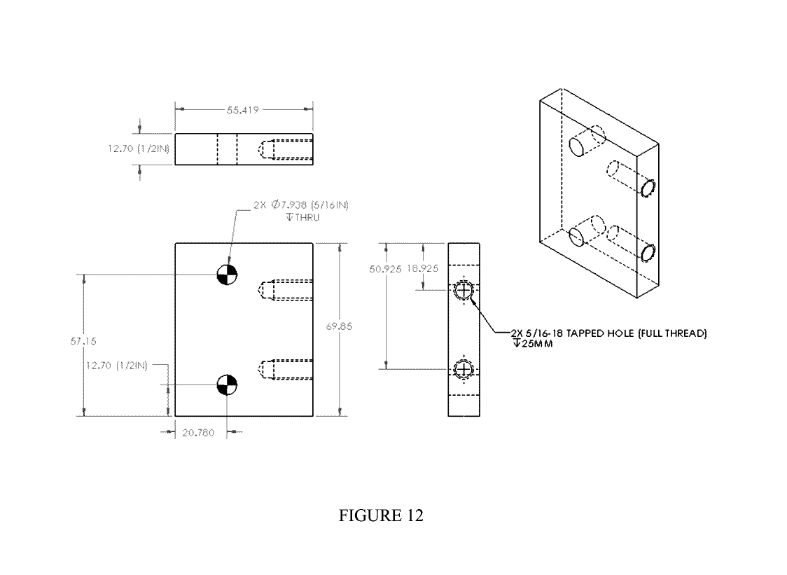

A plasma dynamic laser may also include an optical gimbaling system to precisely align the mirrors of the optical system. The gimbaling system may be comprised of both a moving mount and a fixed mount that holds the output coupler (partially reflective mirror). FIG. 11 illustrates the optics mount which secures the full laser body. The optics mount may be mounted on a T-rail by using a laser mount as illustrated on FIG. 12.

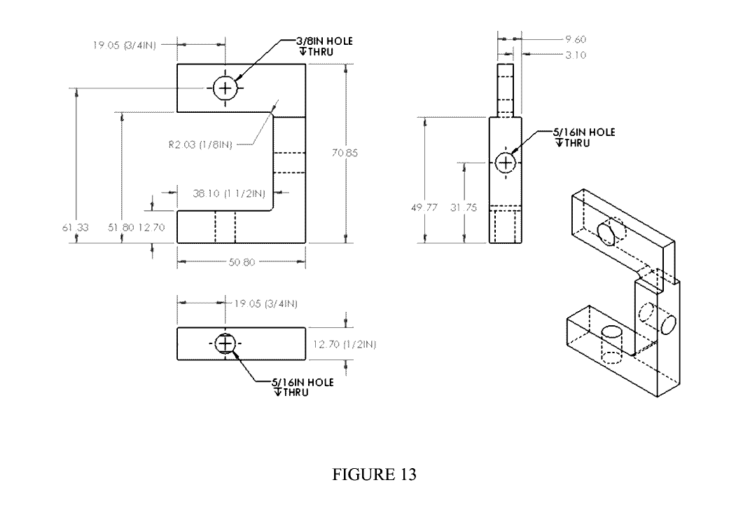

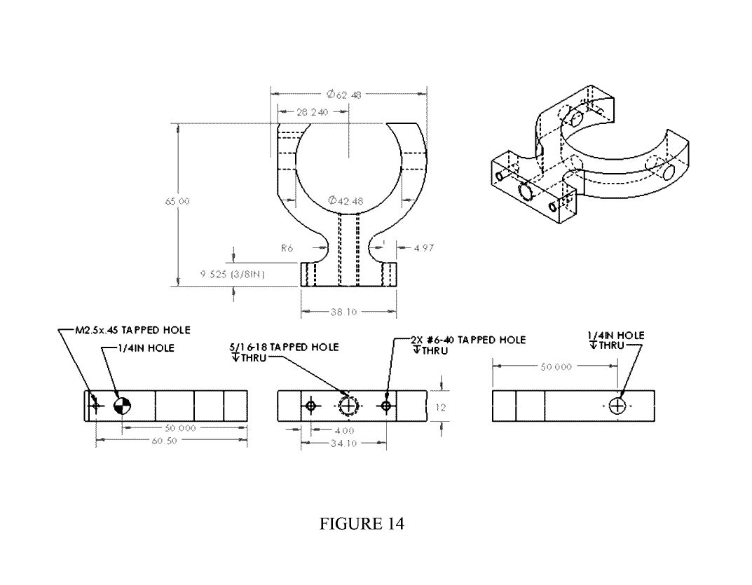

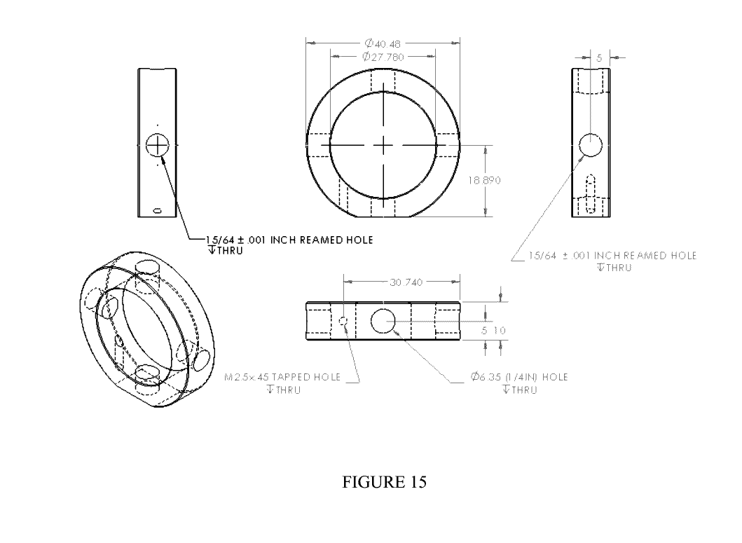

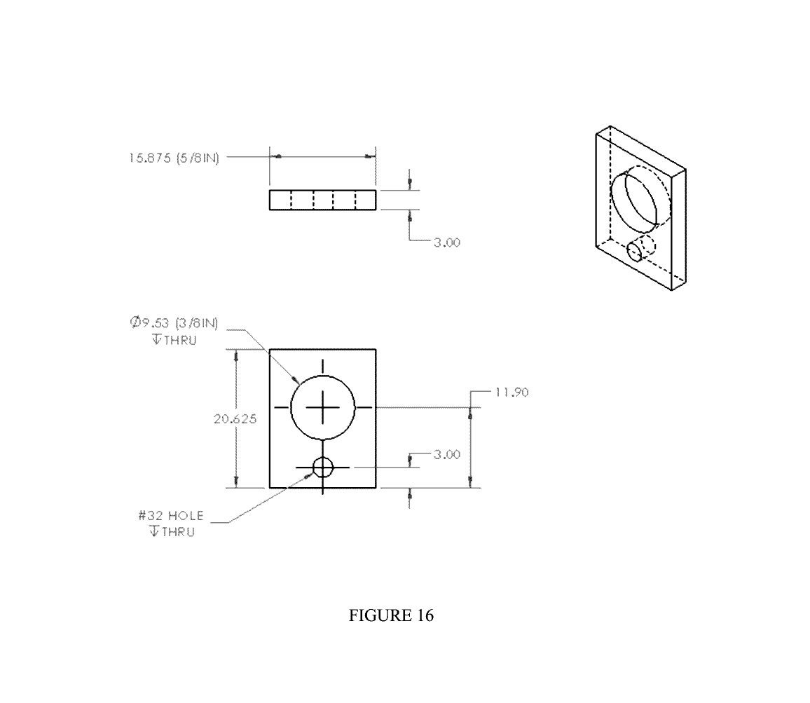

Some embodiments of the gas dynamic laser may include a gimbaling system used to precisely align the mirrors. The gimbaling system is mounted to the T-rail with a Micrometer Bracket as illustrated in FIG. 13. The wishbone gimbal is mounted to the micrometer bracket (illustrated in FIG. 14). The outer gimbal (Illustrated in FIG. 15) is mounted inside the wishbone Gimbal. The mirror retainer plate (Illustrated in FIG. 16), which holds the mirror is mounted inside the outer gimbal.

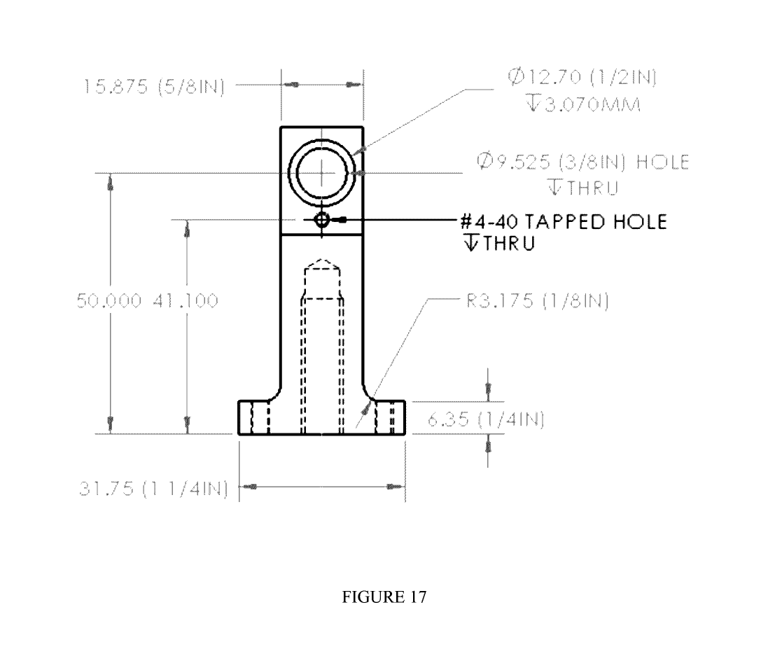

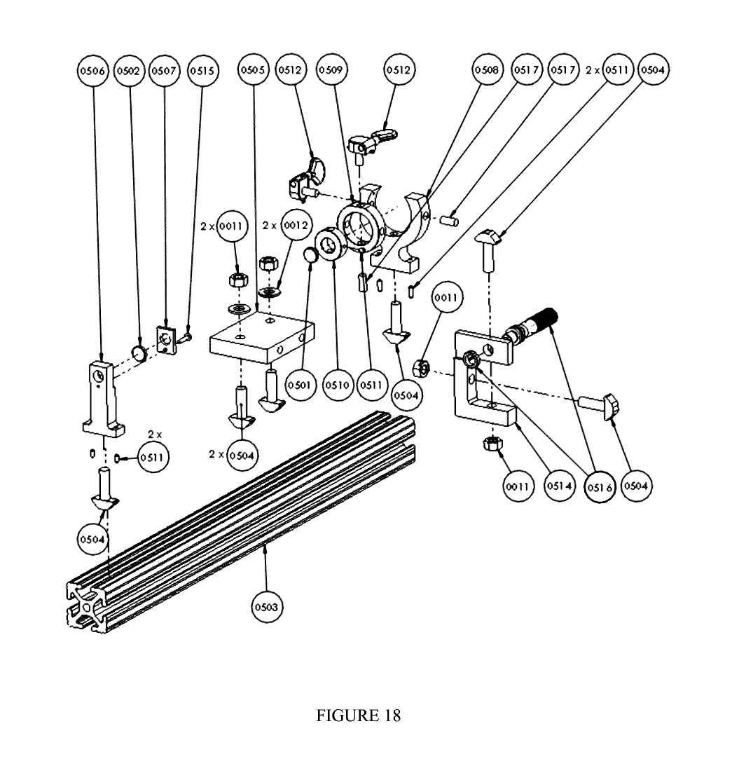

Some embodiments may also include a fixed optical mount which holds a second mirror at a fixed orientation on the T-Rail. FIG. 17 illustrates the fixed mount and retainer plate. FIG. 18 illustrates the complete optical system.

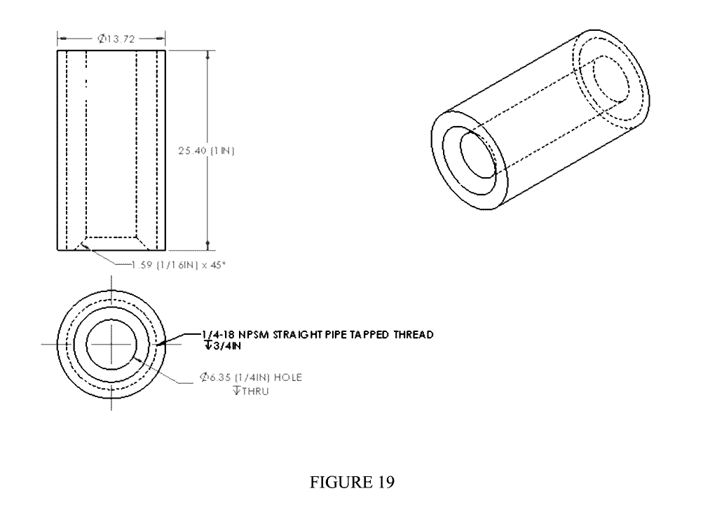

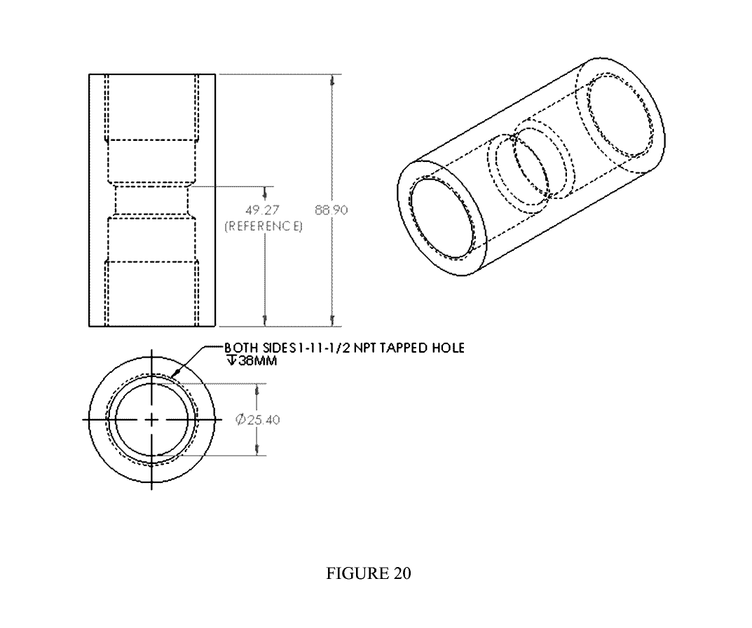

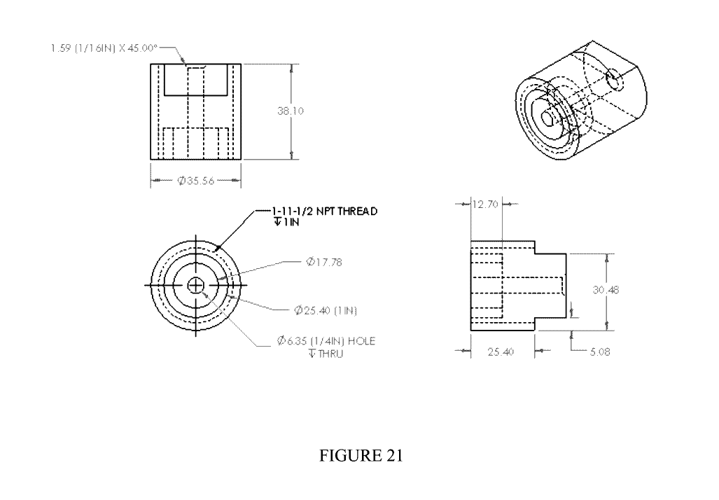

Some embodiments of the disclosed invention connect the furnace which heats the gas to the laser body with a plenum assembly. The plenum assembly may be comprised of a plenum cap, a plenum shell, and a tube to hose connector. FIG. 19 illustrates the tube to hose connector. FIG. 20 illustrates the plenum shell. FIG. 21 illustrates the plenum cap.

Some embodiments of the invention include a furnace to heat gas for the laser. The furnace may be comprised of burners and air blowers, insulation, and be single pass and counter flow. Fuel may be propane or other combustibles.

In order to ensure optimal performance, the supersonic nozzle properties need to be designed so that irregularities are minimized in the duct, which will ensure that shocks are minimized.

Shocks in supersonic airflow can be oblique or detached. Oblique Shocks: Caused by angled intrusions into or away from the duct. Fairly weak. Detached Shocks: Caused by blunt intrusions in the duct. Very strong-extremely bad for laser operation.

Shock Strength and type determined by intrusion angle, therefore the maximun intrusion angle ˜37° or else detached shock will form.

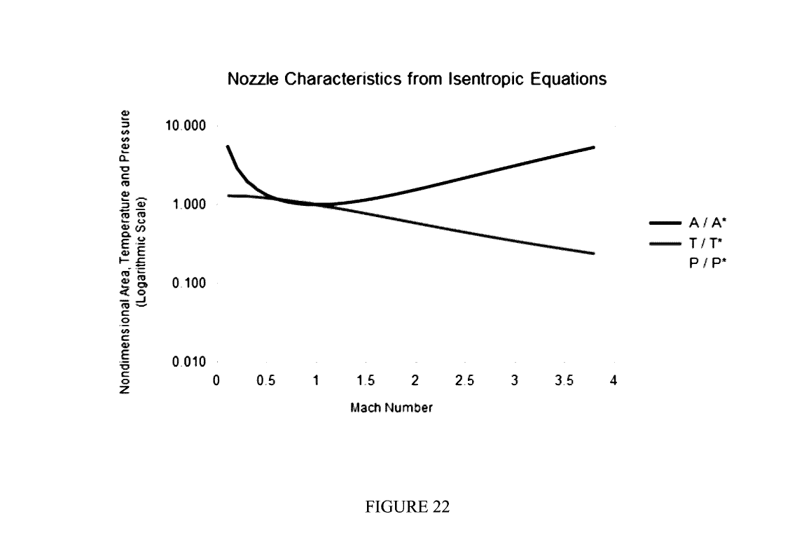

FIG. 22 Illustrates Nozzle properties by mach number, developed via use of these isentropic equations. Semilog—Y scale.

$$\dot{m} = \sqrt{\frac{γ}{R}} \frac{{p}_{1}}{\sqrt{{T}_{1}}} A \cdot {M ( \frac{1}{1 + \frac{γ - 1}{2} {M}^{2}} )}^{\frac{γ + 1}{2 γ - D}}$$

$$\frac{A}{{A}^{*}} = \frac{1}{M} {( \frac{1 + \frac{γ - 1}{2} {M}^{2}}{\frac{γ + 1}{2}} )}^{\frac{γ + 1}{2 γ - D}}$$

$$\frac{p}{{p}^{*}} = \frac{p}{{p}^{*}} / \frac{T}{{T}^{*}} = {[ \frac{\frac{γ + 1}{2}}{1 + ( \frac{γ - 1}{2} ) {M}^{2}} ]}^{\frac{1}{γ - 1}}$$

$$\frac{p}{{p}^{*}} = {[ \frac{\frac{γ + 1}{2}}{1 + ( \frac{γ - 1}{2} ) {M}^{2}} ]}^{\frac{γ}{γ - 1}}$$

$$\frac{T}{{T}^{*}} = \frac{\frac{γ + 1}{2}}{1 + ( \frac{γ - 1}{2} ) {M}^{2}}$$

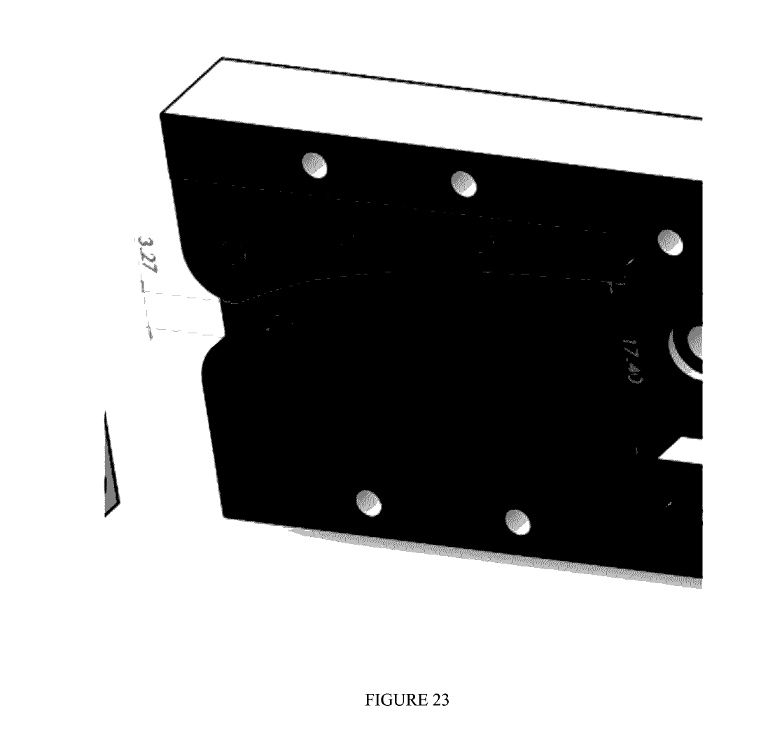

These Isentropic Equations were used to find flow properties throughout the nozzle and diffuser from the properties at their inlets. To produce a Shock-Free Minimum Length Nozzle (Illustrated in FIG. 23), using Isentropic flow equations, critical nozzle areas and mach number were found. Divergent Profile was designed in MATLAB using method of characteristics.

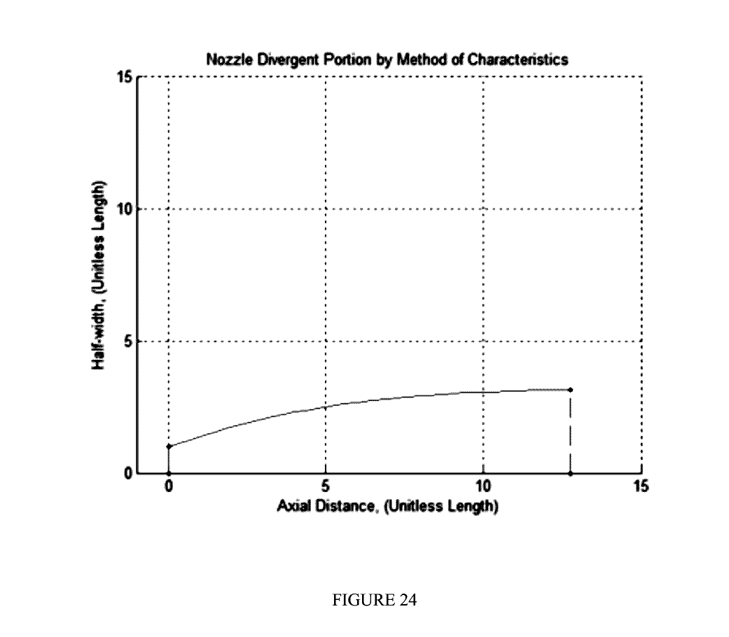

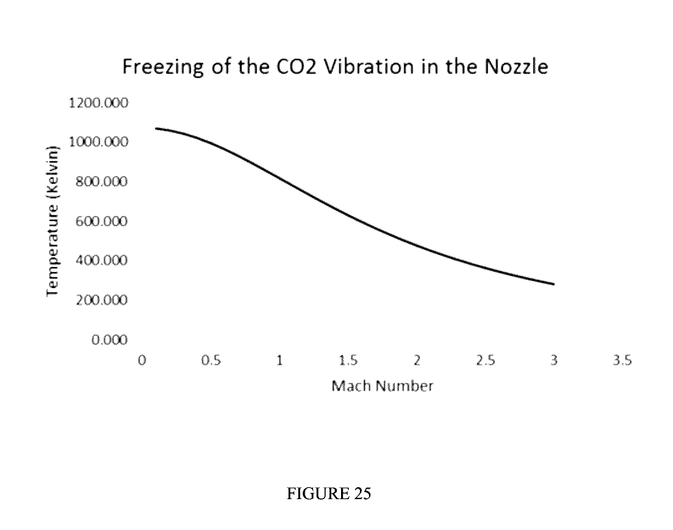

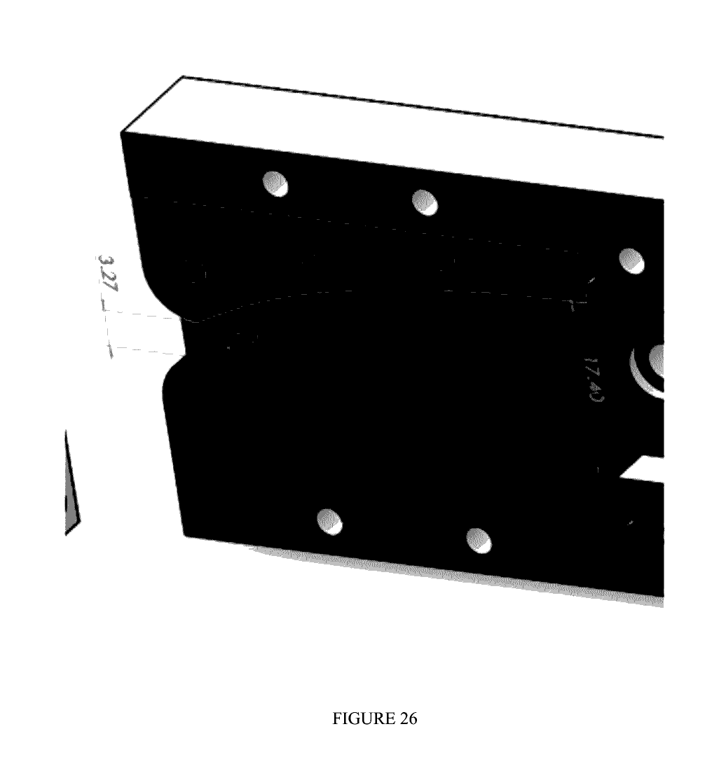

FIG. 24 Illustrates Nozzle Profile as output by Method of Characteristics Program. FIG. 25 Illustrates Nozzle Temperature Drop. Note that temperature falls below the freezing line just before the throat. FIG. 26 Illustrates the assembled nozzle.

Throughout this application, the term “about” is used to indicate that a value includes the standard deviation of error for the device or method being employed to determine the value.

The disclosed system, device, and method of use is generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention.

Terms such as “a”, “an”, and “the” are not intended to refer to only a singular entity, but include the general class of which a specific example may be used for illustration. The terminology herein is used to describe specific embodiments of the invention, but their usage does not delimit the disclosed device or method, except as may be outlined in the claims.

Any embodiments comprising a one component or a multi-component system or device having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific system, device, and method of use described herein. Such equivalents are considered to be within the scope of this invention and are covered by the claims.

All publications, references, patents, and patent applications mentioned in the specification are indicative of the level of those skilled in the art to which this invention pertains. All publications, references, patents, and patent application are herein incorporated by reference to the same extent as if each individual publication, reference, patent, or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The system, devices, and/or methods disclosed and claimed herein can be made and executed without undue experimentation in light of the present disclosure. While the system, device, and methods of this invention have been described in terms of preferred embodiments, it will be apparent to those skilled in the art that variations may be applied to the system, device, and/or methods and in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A CO2-N2-HE gas dynamic laser comprising:
a main body; a propane tank; a gas inlet hose; a pressure regulator; a gas tank; an armature assembly; a plenum assembly; a laser body assembly; an optical control assembly; and a valve piping assembly.

2. The CO2-N2-HE gas dynamic laser of claim 1, wherein said main body is further comprised of two replaceable nozzle plates.

3. The CO2-N2-HE gas dynamic laser of claim 2, wherein said two replaceable nozzle plates are held in place by a dovetail shaped pocket.

4. The CO2-N2-HE gas dynamic laser of claim 1, wherein said main body is made from Nitronic 60 stainless steel.

5. The CO2-N2-HE gas dynamic laser of claim 1, wherein said main body is made from Nitronic 303 stainless steel.

6. The CO2-N2-HE gas dynamic laser of claim 1, wherein said main body is made from Nitronic 60 stainless steel.

7. The CO2-N2-HE gas dynamic laser of claim 1, further comprised of window blocks.

8. The CO2-N2-HE gas dynamic laser of claim 1, further comprised of an optical gimbaling system to precisely align the mirrors of the optical system.

9. The CO2-N2-HE gas dynamic laser of claim 8, wherein said gimbaling system is comprised of a moving mount and a fixed mount that holds the output coupler.

10. The CO2-N2-HE gas dynamic laser of claim 1, further comprised of a plenum assembly.

11. The CO2-N2-HE gas dynamic laser of claim 1, wherein said plenum assembly is comprised of a plenum cap, a plenum shell, and a plenum tube to hose connector.

12. The CO2-N2-HE gas dynamic laser of claim 1, further comprising a furnace assembly.

13. The CO2-N2-HE gas dynamic laser of claim 12, wherein said furnace assembly is further comprised of burners and air blowers.

14. The CO2-N2-HE gas dynamic laser of claim 13, wherein said furnace assembly is further comprised of insulation.

15. The CO2-N2-HE gas dynamic laser of claim 14, wherein said furnace assembly is single pass.

16. The CO2-N2-HE gas dynamic laser of claim 15, wherein said furnace assembly is also counter flow.
